(19) United States
(12) Patent Application Publication
(10) Pub. No.: US 2005/0134196 A1
(43) Pub. Date: Jun. 23, 2005

(54) Fluorescent dimming system

(76) Inventors: Kenneth J. Cook, Troy, MI (US); Jessie D. Swinea, Royal Oak, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/739,558

(22) Filed: Dec. 18, 2003

(51) Int. Cl. H05B 37/02

(52) U.S. Cl. 315/291; 315/224

(57) ABSTRACT

The present invention discloses a dimming system for fluorescent lighting. The system includes a fluorescent tube, a ballast for the fluorescent tube and a dimmer for moving the level of light from the fluorescent tube between a bright state and a dimmer state in a stepped fashion. The dimmer includes two circuits that are electrically isolated from one another but joined through an optical coupler. Depending on the state of the control circuit, current through the fluorescent tube will pass along either a high impedance circuit or a parallel low impedance circuit. A change in the state of the control circuit moves the current flow through either the low impedance circuit or the high impedance circuit resulting in a stepped change in the amount of light generated by the fluorescent tube.

### BACKGROUND OF THE INVENTION

1. Field of the Invention

The invention relates to fluorescent dimming systems, particularly to a system that allows stepped light output from fluorescent lighting between a normal output and a lower or dimmed output.

2. Background Art

Fluorescent lamps provide efficient lighting. However, each lamp usually is controlled at a single level of light output. Recently, dimming ballasts have been developed that allow the reducing of power applied to the fluorescent tube. However, there remains a need for a dimming system that allows for efficient stepping down and up of the light output, with substantially no power loss.

An example of such a need is in the area of public transportation buses. As the bus travels at night, only a low level of lighting is desired, so as to not distract the driver and save energy. However, when the bus stops, there is an immediate need for a higher level of lighting so that the passengers may safely get on and off the bus.

A goal of the present invention is to provide an efficient fluorescent dimming system that provides for efficient stepped light output from the fluorescent lighting between a normal output and a lower or dimmed output. It is also a goal of the present invention that the dimming system be operable with standard ballast systems now on the market. It is another goal that the dimming be accomplished with substantially no power loss.

### SUMMARY OF THE INVENTION

An aspect of the present invention is to provide a system for dimming fluorescent lighting. The system includes fluorescent lighting, ballast for the fluorescent lighting and a dimmer. The dimmer raises and lowers the amount of light from the fluorescent lighting in a stepped fashion between two levels—a bright level and a dimmed level. The dimmer has two circuits electrically isolated from one another, including a dimmer circuit for controlling the circuit flowing through the fluorescent lighting at two levels, one resulting in a bright level of lighting and the second a dimmed level of lighting. The dimmer also includes a control circuit for causing the current in the dimmer circuit to move between the two levels in a stepped fashion. The dimmer circuit may have two parallel branches connected in series to the fluorescent lighting. The first branch has a low impedance and the second branch has a high impedance. The control circuit switches the low impedance branch on and off to provide movement between the two levels in a stepped fashion. The low impedance branch may comprise a diode bridge and transistor such that no current flows through the low impedance branch when the transistor is in the off state, but rather flows through the high impedance branch. When the transistor is in the on state, there is flow through the low impedance branch and no flow through the high impedance branch. The high impedance branch may include a reactive component, such as in the form of a capacitor. The control circuit moves the transistor between the on and off states. The control circuit may be electronically isolated from the dimmer circuit by the interaction of a light emitting diode in the control circuit and an optical transistor in the dimmer circuit.

A further aspect of the present invention is to provide a system particularly suited for dimming fluorescent lighting in the passenger area of public transportation. It includes fluorescent lighting in the passenger area, a ballast for the fluorescent lighting and a dimmer. The dimmer raises and lowers the amount of light from the fluorescent lighting in a stepped fashion between a bright level suitable for allowing substantially safe movement by passengers when the public transportation is stopped and a dimmed level suitable for when the public transportation is moving. The dimmer has two circuits electronically isolated from one another, including a dimmer circuit for controlling the current flowing through the fluorescent lighting at two levels corresponding to the bright level of lighting and the dimmed level of lighting. The dimmer also has a control circuit for causing the current in the dimmer circuit to move between the two levels in a stepped fashion. The control circuit has a control switch that moves between two states, the first state resulting in the stepped change in the current in the dimmer circuit and the second state resulting in a reversal of the stepped change. The control switch may change states in response to the opening and closing of a door of the public transportation. It may include a second manually operated control switch in parallel with the first control switch.

Yet another aspect of the present invention is to provide a system for causing the stepped change of current in a device. The system has two parallel branches connected in series to the device. The first branch has a low impedance and the second branch has a high impedance. The low impedance branch comprises a diode bridge and transistor such that no current flows through the low impedance branch when the transistor is in the off state, but rather flows through the high impedance branch. When the transistor is in the on state, there is flow through the low impedance branch and no flow through the high impedance branch. A control switches moves the transistor between the on and off states. The control circuit may be electronically isolated from the dimmer circuit by the interaction of a light emitting diode in the control circuit and an optical transistor in the dimmer circuit.

### BRIEF DESCRIPTION OF THE DRAWINGS

FIG. 1 is a schematic of the fluorescent dimming system of the present invention.

### DETAILED DESCRIPTION OF THE PREFERRED EMBODIMENT(S)

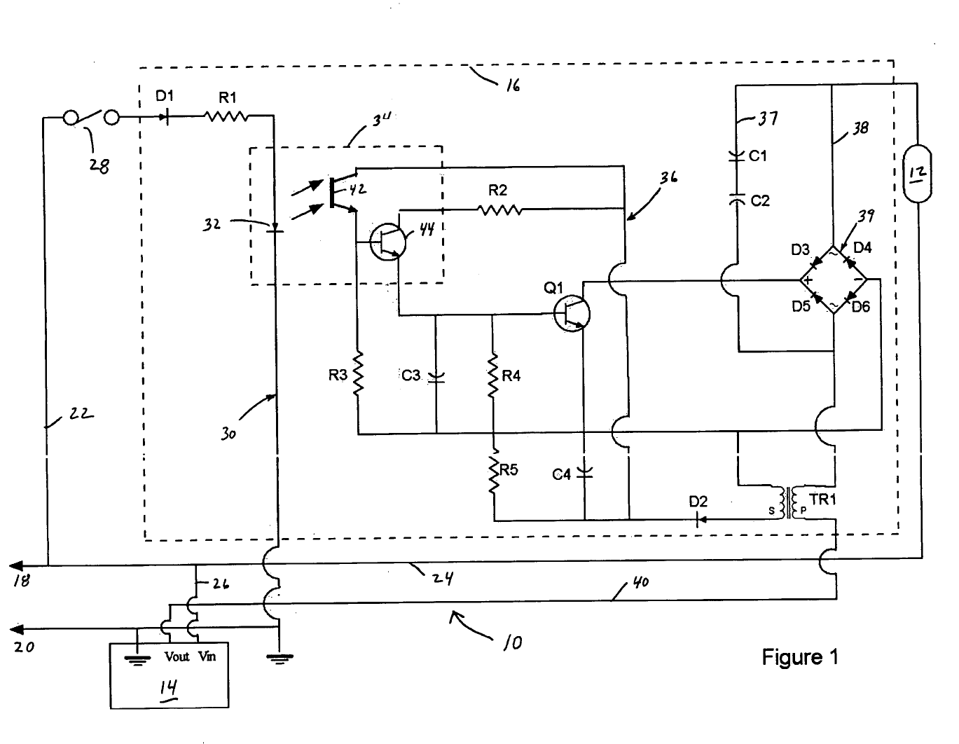

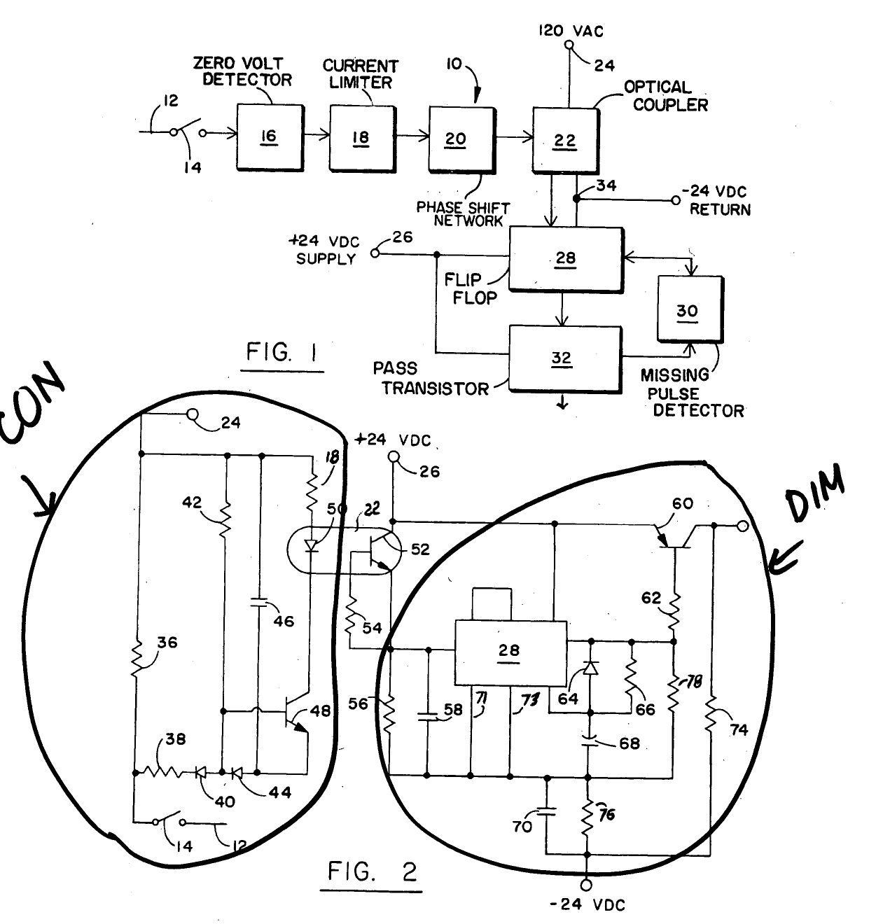

Referring to FIG. 1, there is shown a dimming system for fluorescent lighting 10 including a fluorescent tube 12, a conventional ballast 14 and a dimmer 16. This system is designed for use on fluorescent lighting illuminating the passenger area of the public transportation, such as a bus, but use with other fluorescent lighting is envisioned. Power is supplied to the system through a red plus input 18 from the bus' 24 volt electrical power supply mains and a black negative input 20 from the bus's electrical power supply ground. The red plus power input 18 is supplied by suitable wiring 22, 24, 26 to dimmer control switch 28, fluorescent tube 12 and ballast 14, respectively.

The control switch 28 is part of a control circuit 30 which is grounded to the black negative input 20 and includes diode D1 and resistor R1. Also part of the control circuit is a light emitting diode 32 which is part of optical coupler 34.

A dimmer circuit 36 is connected to fluorescent tube 12. It has two parallel branches 37, 38 connected in series with the fluorescent tube 12. The first branch 37 provides high impedance to current flow and includes capacitors C1, C2. The second branch 38 is configured in series with the fluorescent tube and includes diodes D3, D4, D5, D6. These diodes D3, D4, D5, D6 are connected in the configuration of a bridge 39 in parallel with the capacitors C1, C2. The diode bridge 39 is configured such that its AC inputs are connected to capacitors D3, D4 and its DC side is connected to transistor Q1. The transistor Q1 collector is wired to the positive output of the bridge 38. The transistor Q1 emitter is wired to the negative output of the bridge 38. This enables the DC controlled transistor Q1 to perform as a dimming switch controlling the AC current flow through the bridge. With the transistor in the off state, there is no current flow through the bridge, thus placing a high impedance in parallel with the capacitors C1, C2. This action has the capacitors C1, C2 remain in series with the fluorescent tube, thus dimming tube 12. Since the dimming is accomplished through use of capacitors, which are reactive components, there is substantially no power loss. The dimmer circuit 36 is connected to ballast 14 by wire 40.

The control switch 28 has two states, in this embodiment, two positions, open and closed. When the control switch 28 is in the closed position, the control circuit 30 is energized. This energizes optical diode 32. The light from optical diode 32 causes optical transistor 42 of optical coupler 34 to be turned on. The output from optical transistor 42 turns on a second optical coupler transistor 44. Optical coupler 34 provides forward transfer gain while electrically isolating the two circuits. When transistor 44 is turned on, transistor Q1 is turned on. AC current then passes through the bridge 39, which rectifies the current to pulsating DC and passes through transistor Q1, and thus not through capacitors C1, C2. This enables the fluorescent tube 12 to operate at maximum brightness.

Optical coupler 34 enables safe control operation of transistor Q1 which is floating at high voltage. The use of an optical coupler electronically isolates voltage of the control circuit 30 from the dimmer circuit 36.

DC supply voltage, used by the dimmer circuit 36 operation, is obtained from the tube 12 current flowing through transformer TR1. The secondary AC voltage of transformer TR1 is rectified by diode D2 and filtered by capacitor C4 to produce the DC voltage to operate the dimmer circuit. Resistor R5 bleeds off charge from capacitor C4 at shutdown. A bias network consisting of resistors R2, R3, R4 and capacitor C3 generally provide current flow during the operation of optical coupler 34 and transistor Q1.

Although the preferred embodiment shows control of a single fluorescent tube 12, the switch 28 is suitable for controlling a fluorescent light source of multiple fluorescent tubes so to allow concurrent stepped dimming and brightening. When used on a bus, the bright level of lighting is envisioned as that desirable for easy movement around the bus by passengers, while the dimmed level is envisioned for when the bus is in motion, so that the driver is not unduly distracted.

In one example mode of operation the fluorescent lighting is started in its non-dimmed position with switch 28 closed. The electronic ballast provides an AC voltage (e.g., a 30 KHz AC voltage). This voltage has sufficient power to start and maintain current through the fluorescent tube 12. The fluorescent tube 12 performs as an open current until it initially conducts, then it changes characteristics to that of a constant voltage drop device and the current through it is limited. When the ballast 14 initially starts, its output voltage, across a typical 40 inch to 60 inch long fluorescent tube, will generally be 1000 to 2000 volts. After the tube conducts, its voltage will drop to its Zener voltage, typically 80 to 150 volts. Since control switch 28 is closed, the optical coupler 34 is activated and transistor Q1 will be on. The fluorescent lighting will be at its normal bright condition.

Secondary devices may be used to control switch 28. Thus, there may be a manually activated switch used by the driver or cleaning crew to allow manual control of whether the lighting is dimmed or not. There could also be a parallel device to control switch 28 tied to when the doors of the bus open or close. Multiple switches in series or parallel may be used. During use of the bus for transportation, it is desirable that whenever the doors of the bus are open, the switch is open and the fluorescent lights are at their bright condition.

However, when the bus is moving it is desirable for the lights to be in a dimmed position. Switch 28 is moved to its open position to dim the flourescent lighting. This de-energizes optical coupler 34, resulting in transistor Q1 being off. Since the current can no longer flow through bridge 39, the current passes through the capacitors C1, C2, i.e., a branch of higher impedance. This reduces the current flow through the flourescent tube, thus dimming the flourescent lighting.

The dimmer 16 is low cost since it is designed to use off the shelf items. In the preferred embodiment, the following parts are used.

| Part | Description |
|---|---|
| D1 | 1N4004 diode |
| D2 | 1N5819 diode |
| D3 | 1N4004 diode |
| D4 | 1N4004 diode |
| D5 | 1N4004 diode |
| D6 | 1N4004 diode |
| R1 | 2700 ohm resistor |
| R2 | 390 ohm resistor |
| R3 | 10,000 ohm resistor |
| R4 | 470 ohm resistor |
| R5 | 100,000 ohm resistor |
| C1 | 33 nF capacitor |
| C2 | 33 nF capacitor |
| C3 | 22 nF capacitor |
| C4 | 22 mF capacitor |
| Q1 | BU1507AX transistor by Phillips |
| ICI | 6N139 optical coupler |

The transformer TR1 uses a SP269 core with 4 turns of 24 awg wire (magwire) on the primary coil and 33 turns of 24 awg wire (magwire) on the secondary coil.

The dimmer 16 is power efficient and does no require heat sinking. The preferred embodiment works over a wide temperature range, −30° F. to 165° F.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A fluorescent dimming system comprising
fluorescent lighting:
ballast for the fluorescent lighting:
a dimmer for raising and lowering the amount of light from the fluorescent lighting in a stepped fashion between a bright level and a dimmed level, the dimmer has two circuits electrically isolated from one another comprising:
a dimmer circuit for controlling the current flowing through the fluorescent lighting after the initial conduction of the fluorescent lighting at two levels with current flow a high lever resulting in the bright level of lighting and current a lower level resulting in the dimmed level of lighting; and
a control circuit for causing the current in the dimmer circuit to move between the two levels in a stepped fashion.

2. The fluorescent dimming system of claim 1 where the dimmer circuit has two parallel branches connected in series to the fluorescent lighting,
the first branch having being a low impedance connected to the fluorescent lighting providing a current flow through the fluorescent lighting at a first level for yielding the bright level of lighting, and
the second branch having a high impedance connected to the fluorescent lighting providing a current flow through the fluorescent lighting at a lower level for yielding the dimmed level of lighting; and
the control circuit switches the low impedance branch on and off to provide movement between the two levels in a stepped fashion.

3. The fluorescent dimming system of claim 2 where the low impedance branch comprises a diode bridge and transistor having a collector, an emitter and two states, on and off, where the transistor collector is joined to the positive output of the bridge and the transistor emitter is joined to the negative output of the bridge and no current flows through the low impedance branch when the transistor is in the off state but rather flows through the high impedance branch, and there is flow through the low impedance branch when the transistor is in the on state but no flow through the high impedance branch, and
where the control circuit moves the transistor between the on and off states.

4. The fluorescent dimming system of claim 3 where the high impedance branch comprises a reactive component.

5. The fluorescent dimming system of claim 4 where there the reactive component comprises a capacitor.

6. The fluorescent dimming system of claim 3 where the control circuit is isolated from the transistor by the interaction of a light emitting diode in the control circuit and an optical transistor in the dimmer circuit.

7. The fluorescent dimming system of claim 2 where the high impedance branch comprises a reactive component.

8. The fluorescent dimming system of claim 7 where there the reactive component comprises a capacitor.

9. The fluorescent dimming system of claim 1 where the control circuit has a control switch that moves between two states, the first state resulting in a stepped change in current in the dimmer circuit and the second state resulting in a reversal of the stepped change.

10. The fluorescent dimming system of claim 1 where the control circuit is electronically isolated from the dimmer circuit by the interaction of a light emitting diode in the control circuit and an optical transistor in the dimmer circuit.

11. A system for dimming fluorescent lighting in an area for passengers of public transportation comprising:
fluorescent lighting in the passenger area;
ballast for the fluorescent lighting;
a dimmer for raising and lowering the amount of light from the fluorescent lighting in a stepped fashion between a bright level suitable for allowing substantially safe movement by passengers when the public transportation is stopped and a dimmed level suitable for when the public transportation is moving, the dimmer has two circuits electrically isolated from one another comprising:
a dimmer circuit for controlling current flowing through the fluorescent lighting after initial conduction of the fluorescent lighting at two levels with current flow a high lever resulting in the bright level of lighting and current a lower level resulting in the dimmed level of lighting; and
a control circuit for causing the current in the dimmer circuit to move between the two levels in a stepped fashion.

12. The system for dimming fluorescent lighting of claim 11 where the control circuit has a control switch that moves between two states, the first state resulting in the stepped change in current in the dimmer circuit and the second state resulting in a reversal of the stepped change.

13. The system for dimming fluorescent lighting of claim 12 where the control switch changes state in response to the opening and closing of a door of the public transportation.

14. A system for causing the stepped change of current in a device comprising:
a low impedance branch connected in series to the device providing a current flow through the device at a first level for a given voltage; and
a high impedance branch connected in parallel to low impedance branch and connected in series to the device, the high impedance branch providing a current flow through the device at a lower level for a given voltage, where
the low impedance branch comprises a diode bridge and transistor, which has a collector, an emitter and two states, on and off, where the transistor collector is joined to a positive output of the bridge and the transistor emitter is joined to a negative output of the bridge and no current flows through the low impedance branch when the transistor is in the off state but rather a current flows through the high impedance branch, and there is current flow through the low impedance branch when the transistor is in the on state but no flows through the high impedance branch, and
a control switch electronically isolated from the transistor moves the transistor between the on and off states.

15. The system of claim 14 where the transistor moves between its on and off states in response to the state of current flow through an optical transistor which is responsive to light emitted from a light emitting diode on the same circuit as the control switch.
